(19) United States
(12) Patent Application Publication
(10) Pub. No.: US 2012/0166935 A1
(43) Pub. Date: Jun. 28, 2012

(54) AUTOMATIC ASSOCIATION OF GOVERNMENT BRAND INFORMATION WITH DOMAIN AND SOCIAL MEDIA AVAILABILITY

(75) Inventor: Raj Vasant Abhyanker, Cupertino, CA (US)

(73) Assignee: Trademarkia, Inc., Mountain View, CA (US)

(21) Appl. No.: 13/333,705

(22) Filed: Dec. 21, 2011

Related U.S. Application Data
(60) Provisional application No. 61/427,124, filed on Dec. 24, 2010.

(51) Int. Cl. G06F 17/00

(52) U.S. Cl. 715/234

(57) ABSTRACT

A method includes accessing a markup language information is associated with a brand name. The method further includes applying an algorithm to analyze availability of the brand name on any one of a domain and a social media site. In addition the method includes automatically generating a search result comprising at least one of an availability of the brand name as a user name of the social media site and as a domain name based on the application of the algorithm. Furthermore, the method includes associating the search result with a government information identified in the markup language information. The method also includes presenting the associated search result and the government information on a brand availability page.

### RELATED APPLICATIONS

This application claims priority to provisional application Ser. No. 61/427,124 filed Dec. 24, 2010, entitled: “Automatic association of government brand information with domain and social media availability,” and the application is incorporated by reference herein in its entirety.

### FIELD OF TECHNOLOGY

This disclosure relates generally to an enterprise method and system, more particularly, to a method and/or a system of automatic association of government brand information with domain and social media availability.

### BACKGROUND

Government databases may contain important brand information pertaining to intellectual property rights, such as a list of registered trademarks. For example, the United States Patent and Trademark Office's (USPTO) Trademark Electronic Search System (TESS) may make available to the public, a list of registered trademarks. Currently, there is widespread brand misuse on domain names and social media sites. People may be unaware of a rightful owner of a brand and may be unable to associate the brand with the owner of the brand. Further, people and companies known as “cyber squatters” may purposefully use another company's brand information obtained from such a government database to reserve a page on a social media site or purchase a domain name. Cyber squatters may do this in order to sell the brand name page back to the owner of the brand, or to redirect traffic to the cybersquatter's website. This misappropriation of brand information presents a problem for the brand, which may suffer dilution of the trademark or a likelihood of confusion about which page or domain is associated with the trademarked brand. The brand may also suffer large amounts of lost revenue as a result of cybersquatting.

### SUMMARY

A method, an apparatus and/or a system are disclosed of automatic association of government brand information with domain and social media availability.

In one aspect, a method includes accessing a markup language information of a government registry, and determining which of the markup language information is associated with a brand name. The method further includes applying an algorithm to analyze availability of the brand name on any one of a domain and a social media site. In addition, the method includes automatically generating a search result including one or more of an availability of the brand name as a user name of the social media site and as a domain name based on the application of the algorithm.

Further, the method includes associating the search result with a government information identified in the markup language information, and presenting the associated search result and the government information on a brand availability page. The method further may also include automatically generating a thumbnail view of each item of the search result on the thumbnail view page. The thumbnail view page may include a set of screenshots presented in a tiled fashion, so that availability and infringement is visually inspectable in each of the set of screenshots generated in the thumbnail view.

In another aspect, a method may include analyzing an on page content associated with one or more of a domain and a social media site to determine either a presence or an absence of a frequently occurring string of data indicating an available status and a reserve status of a brand name on either a domain or a social media site. In addition, the method may include automatically generating a search result including one or more of an availability of the brand name as a user name of the social media site and as a domain name based on the analysis of the on page content. Further, the method includes associating the search result with a government information identified in a markup language information of a government database.

The system may include a network, and a government server having a government database coupled with the network. Further, the system may include a search server having a module coupled with the network to automatically generate a search result including one or more of an availability of a brand name of the government database as a user name of the social media site or as a domain name based on an the analysis of the on page content. Additionally, the method includes a client device coupled to the search server to present the search result with government information identified in the government database.

### BRIEF DESCRIPTION OF THE VIEWS OF DRAWINGS

The embodiments of this invention are illustrated by way of example and not limitation in the figures of the accompanying drawings, in which like references indicate similar elements and in which:

FIG. 1 is a schematic view of a system of automatic association of government brand information with domain and social media availability.

FIG. 2 is an expanded view of the search server of FIG. 1, according to one or more embodiments.

FIG. 3 is a schematic view of a brand name search and generation of a brand availability page, according to one or more embodiments.

FIG. 4A is a thumbnail view with screenshots, according to one or more embodiments.

FIG. 4B is a thumbnail view with larger screenshots, according to one or more embodiments.

FIG. 5 is a thumbnail view of a brand availability page, according to one or more embodiments.

FIG. 6 is a process flow diagram detailing the operation involved in the automatic association of government brand information with domain and social media availability, according to one or more embodiments.

Other features in the present embodiments will be apparent from the accompanying drawings and from the detailed description that follows.

### DETAILED DESCRIPTION

Example embodiments, as described below may be used to provide a method and/or a system of automatic association of government brand information with domain and social media availability. Although the present embodiments have been described with reference to specific example embodiments, it will be evident that various modifications and changes may be made to these embodiments without departing from the broader spirit and scope of the various embodiments.

Social media marketing may be part of integrated marketing communication plans used by small businesses, corporate and non-profit organizations. Integrated marketing communications may be a multifaceted, orchestrated marketing and advertising practice organizations may follow to connect with their target markets. Integrated marketing communications coordinates promotional elements: advertising, personal selling, public relations, publicity, direct marketing and sales promotion. Increasingly, viral marketing campaigns may also be grouped into integrated marketing communications. In the traditional marketing communications model, the content, frequency, timing, and medium of communications by the organization is in collaboration with an external agent, i.e. advertising agencies, marketing research firms and public relations firms. However, the growth of social media has impacted the way organizations communicate. With the emergence of Web 2.0, the internet provides a set of tools that allow people to build social and business connections, share information and collaborate on projects online.

Social media marketing programs usually center on efforts to create content that attracts attention and encourages readers to share it with their social networks. A corporate message spreads from user to user and presumably resonates because it appears to come from a trusted, third-party source, as opposed to the brand or company itself. Hence, this form of marketing is driven by word-of-mouth, meaning it results in earned media rather than paid media.

Social media has become a platform that is easily accessible to anyone with internet access. Increased communication for organizations fosters brand awareness and often, improved customer service. Additionally, social media serves as a relatively inexpensive platform for organizations to implement marketing campaigns. With emergence of channels like Twitter® and Facebook®, the barrier to entry in social media is greatly reduced.

Social networking websites like Facebook®, Twitter®, Youtube® and blogs may allow individuals to interact with one another and build relationships. When products or companies join those sites, people can interact with the product or company. That interaction feels personal to users because of their previous experiences with social networking site interactions.

Social networking sites like Twitter®, Facebook®, YouTube® and blogs allow individual followers to “retweet” or “repost” comments made by the product being promoted. By repeating the message, all of the users' connections are able to see the message, therefore reaching more people. Social networking sites act as word of mouth. Because the information about the product is being put out there and is getting repeated, more traffic is brought to the product/company.

Through social networking sites, products/companies can have conversations and interactions with individual followers. This personal interaction can instill a feeling of loyalty into followers and potential customers. Also, by choosing whom to follow on these sites, products can reach a very narrow target audience.

On Twitter®, companies may be able to promote products on an individual level. The use of a product can be explained in short messages that followers are more likely to read. These messages appear on followers' home pages. Messages can link to the product's website, Facebook® profile, photos, videos, etc. This link provides followers the opportunity to spend more time interacting with the product online. This interaction can create a loyal connection between product and individual and can also lead to larger advertising opportunities. Twitter® promotes a product in real-time and brings customers in.

In contrast, Facebook® profiles are more detailed than Twitter. They may allow a product to provide videos, photos, and longer descriptions. Videos can show when a product can be used as well as how to use it. These also can include testimonials as other followers can comment on the product pages for others to see. Facebook®can link back to the product's Twitter® page as well as send out event reminders. Facebook® promotes a product in real-time and brings customers in.

As marketers see more value in social media marketing, advertisers continue to increase sequential ad spend in social. Strategies to extend the reach with Sponsored Stories and acquire new fans with Facebook® ads continue to an uptick in spend across the site.

Similarly, blogs allow a product or company to provide longer descriptions of products or services. The longer description can include reasoning and uses. It can include testimonials and can link to and from Facebook®, Twitter® and many social network and blog pages. Blogs can be updated frequently and are promotional techniques for keeping customers. Other promotional uses are acquiring followers and subscribers and direct them to your social network pages.

Over time, since the emergence of these tools, millions of users have become familiar with these tools—sites like Facebook®, Twitter®, Youtube®, blogs and other social media tools and are using these tools within their mirco-networks. The micro network may be their group of friends, followers, or connections. A growing number of businesses and their marketing groups are using Web 2.0 tools and these social media applications to collaborate with consumers on product development, service enhancement and promotions. These tools can be used to do what traditional advertising does: persuade consumers to buy a company's products or services. An executive can write a blog, for instance, that regularly talks up the company's goods. Or instead, companies may use these tools to get the consumers involved, inviting them to participate in marketing-related activities from product development to feedback to customer service.

For example, a marketing manager may obtain consumer feedback and ideas for product development through the online community. This may be much faster and cheaper than the traditional focus groups and surveys used in the past. The conversations consumers have with each other may provide valuable insights to the marketing manager including gift ideas for specific occasions, such as a college graduation, and the prices consumers are willing to pay for different gifts.

In another example, a large technology company may use several Web 2.0 tools to improve collaboration with both its business partners and consumers. Among other things, company employees may create wikis—Web sites that allow users to add, delete and edit content—to list answers to frequently asked questions about each product, and consumers have added significant contributions. For instance, within days of the release of a new piece of software by the company, consumers may spot a problem with it and post a way for users to deal with it. Having those solutions available so quickly showed customers that the company was on top of problems with its products.

Within social media marketing, companies may make sure that consumers and users of the tools use the online community to network among themselves on topics of their own choosing. That way the site isn't all about the company, it's also about them. For instance, a toy company that created a community of hundreds of mothers to solicit their opinions and ideas on toys also enables them to write their own blogs on the site, a feature that many use to discuss family issues.

Other companies may provide more-direct incentives: cash rewards or products, some of which are available only to members of the online community. Still others may offer consumers peer recognition by awarding points each time they post comments, answer questions or contribute to a wiki entry. Such recognition not only encourages participation, but also has the benefit of allowing both the company and the other members of the community to identify experts on various topics.

Since the emergency of social media marketing and social media monitoring, companies are increasingly offering solutions to help companies manage their social media presence, by archiving business communications or managing individual posts on Twitter® and Facebook®. For many trademark owners it's their most important asset. Goods are most easily identified by a trademark and brand owners count on their customers being able to identify with the trademark for repeat business. The proliferation of wide spread use of social media and usernames or other identifiers on these social media websites may be posing a threat to brands.

Brands like GUCCI®, VERSACE®, PRADA® are automatically associated with quality, wealth and beauty, Consumers that are able to afford these goods will tend to stick with these brands and can easily distinguish their favorite products from the competition including those at the lower end of the scale. Similarly famous personalities have teams that work on their brand and to protect their brand to ensure that this brand can be capitalized to make considerable amounts of money from merchandise and appearances.

Brand owners may need to pay close attention to avoid dilution of their trademark by having it genericized. Dilution of a trademark may occur when a well-known trademark is used so often that it becomes generic in the view of the consumer.

Social media marketing has been an increasing trend for businesses in the last few years. Social media marketing may be defined as a group of Internet-based applications that build on an ideological and technological foundations that allow a creation and exchange of user-generated content. For example, this may refer to applications like Facebook®, Twitter®, MySpace® and other such applications that allow for the creation of user generated content. Within these applications a user may select a username for himself, or the application may generate a username for the user. Overtime, the username may be associated with a particular user and the user may develop a fan following or be associated with the username. The username may become a brand in some cases. In other cases, another user may choose a brand name of the first user on another application even though the first user may have developed a brand with his username. The first user may have an interest in monitoring all social media applications to make sure that no one else uses his brand to eliminate chances of confusion or brand dilution. This may be referred to as social media monitoring. Social media monitoring may refer to monitoring aspects of social media to follow user generated content. It may also refer to ensuring that an identity of a user, through the username is verified, and to build and protect brands within social media. Social media monitoring may further refer to protecting brands within all social media applications. This may be extended to making sure that other users do not use or apply for trademarks of the same name being used by the first user or brand owner.

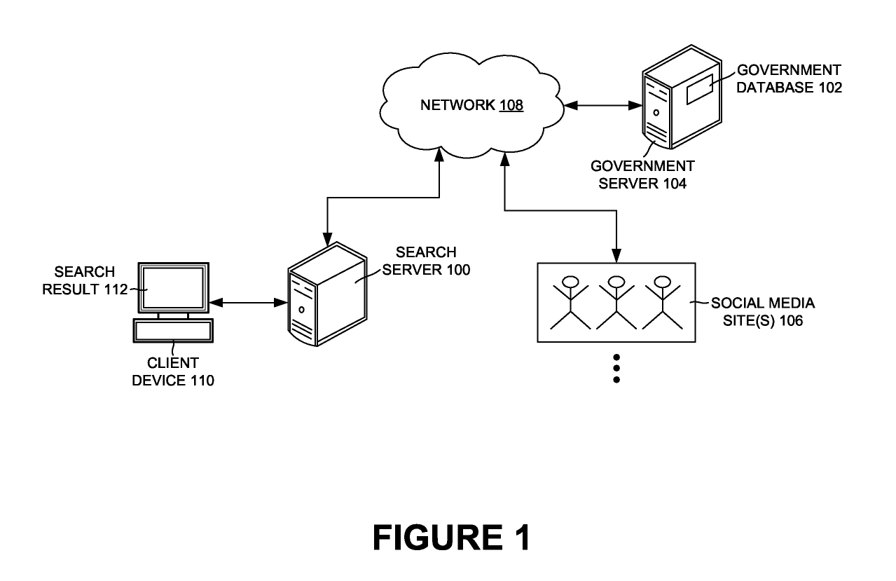

FIG. 1 is a schematic view of a system of automatic association of government brand information with domain and social media availability. In one or more embodiments, a client device 110 is communicatively coupled to a search server 100, a government server 104 and at least one social media site 106. In one or more embodiments, the search server 100, government server 104 and social media site 106 are communicatively coupled through a network 108. In one or more embodiments, the network 108 may be built with a combination of computer hardware and software. For example, the network 108 may include a Personal Area Network (PAN), Local Area Network (LAN), Campus Area Network (CAN), Metropolitan Area Network (MAN), Wide Area Network (WAN), and/or Global Area Network (GAN), etc.

In one or more embodiments, the government server 104 may include a government database 102 coupled with the network 108. In one or more embodiments, the government database 102 may include updated information of a trademark, the present status of the trademark and/or the information of newly filed trademarks. For example, the government database 102 may include the United States Patent and Trademark office (USPTO) Trademark electronic search System (TESS) and/or a European Union trademark search system, etc. In one or more embodiments, the government database 102 may include a set of details about the trademark, including name and address of an applicant of the trademark. In one or more embodiments, the government database 102 may further include a status of the trademark filing. For example a trademark may have been filed, but may not yet be registered, and may be still under the process of getting registered. In another example, the trademark may be allowed, but may not be registered and may need further information from the application of the trademark. In yet another example, the trademark may be indefinitely suspended.

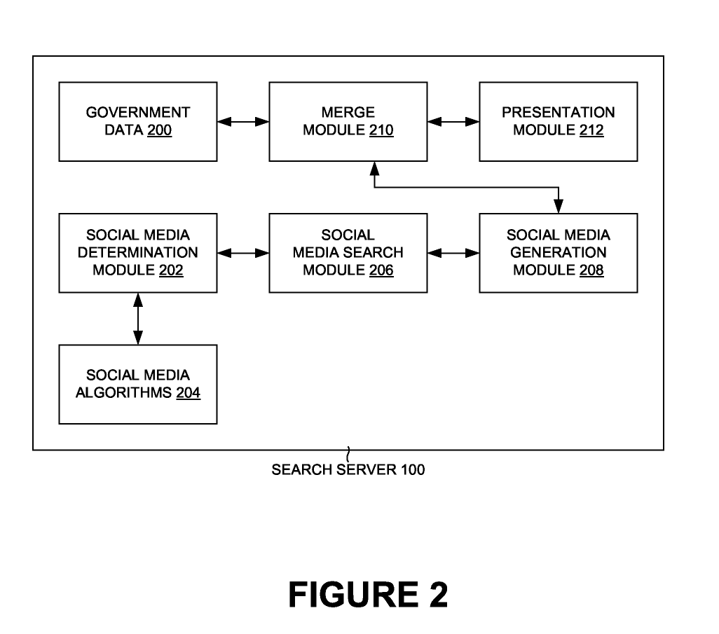

In one or more embodiments, the search server 100 may be communicatively coupled with client device 110. In one or more embodiments, the search server 100 may include modules (as illustrated in FIG. 2). In one or more embodiments, the search server 100 may be coupled with the network 108 to automatically generate a search result 112 displaying the brand availability on a social media site 106. The social media site may be YouTube™, Twitter™, FourSquare™, Facebook™, Flickr™, Metacafe™, Blogcatalog™, Slashdot™, Kaboodle™, or any other social media or social networking site. In one or more embodiments, the search result 112 may include brand name availability from the government database 102 as a user name on the social media site 106. The government database 102 may include United States Patent and Trademark office (USPTO) Trademark electronic search System (TESS) and/or a European Union trademark search system, etc. In one or more embodiments, the search server 100 may include a domain name based on the analysis of the page content. A brand name may include a trademarked name or a business or service name such as Pizza Hut™, Dell™, Nikon™, etc.

FIG. 2 is an expanded view of a search server of FIG. 1, according to one or more embodiments. In one or more embodiments, a social media search module 206 may be configured to perform a search by implementing a social media algorithm 204 through a social media determination module 202. In one or more embodiments, the social media algorithm 204 may include a proprietary algorithm. A proprietary algorithm may be a sequence of steps and/or rules performed to achieve a specific goal, belonging to a commercial company that is the intellectual property of the owner. In one or more embodiments, the social media algorithm 204 may be a string searching algorithm. A string searching algorithm may be a string algorithm that tries to find a place where one or several strings (also known as patterns) are found within a larger string or text. The presence or absence of a given string may indicate to the search server whether or not the brand name is available or not on the social media site or domain.

In one or more embodiments, the social media determination module 202, communicatively coupled to the social media algorithm 204, may select a suitable algorithm according to the search query of the social media search module 206 from social media algorithms 204. For example, in one or more embodiments, the social media algorithms may include algorithms that search for similar brand names. The algorithm may format the trademark name entered by the user and search for all marks both within the government data 200 and social media sites 106 by automatically removing stop words, such as spaces or hyphens or special characters. For example, the search query may be “jack in the box”, but the algorithm may automatically search for “jack in the box,” “jackinthenbox,” “jack in thebox” and all other combinations thereof. The social media determination module 202 may select the suitable algorithm based on a search query entered by a client through the client device. In one or more embodiments, the client device may be communicatively coupled to a data processing system.

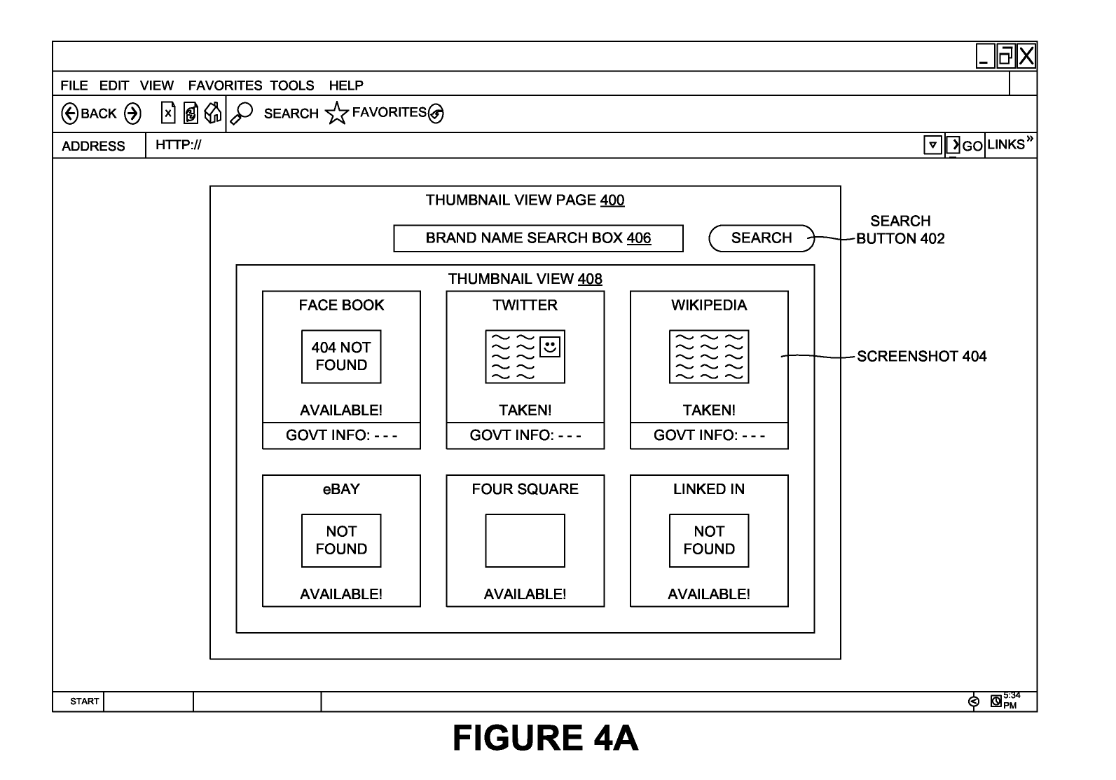

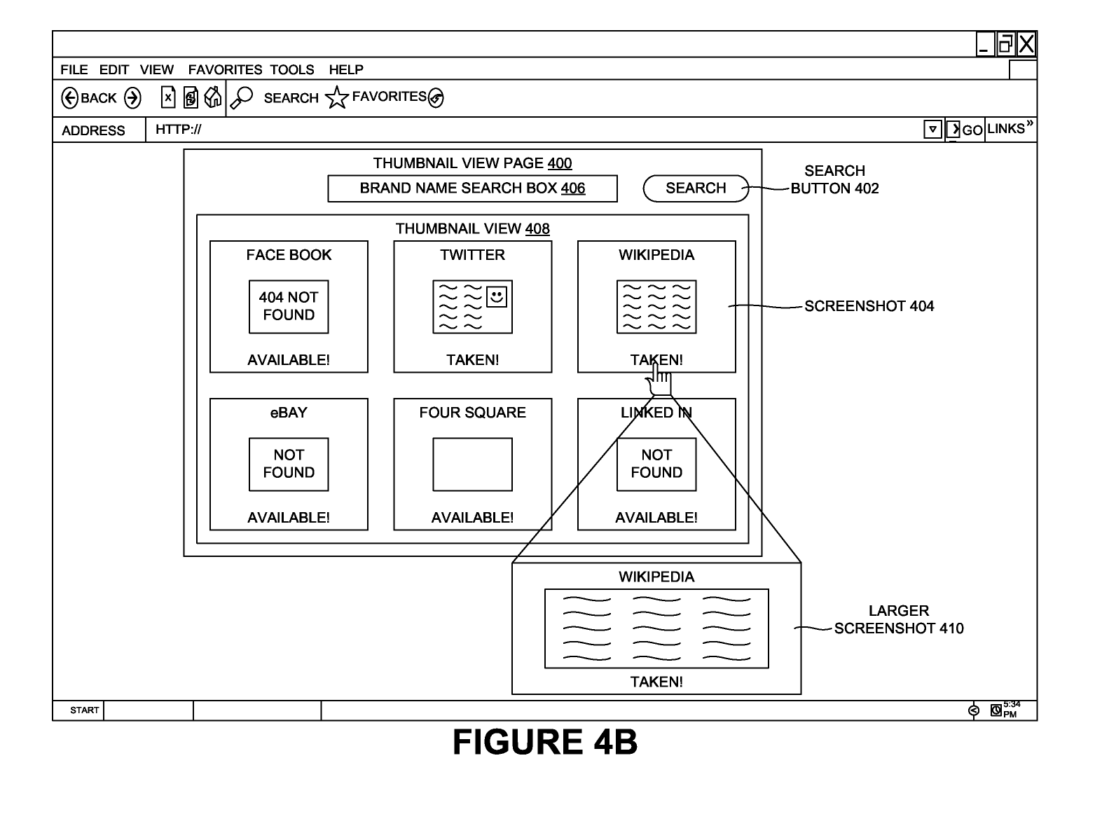

A social media generation module 208 may be communicatively coupled to social media search module 206 and to a merge module 210. The social media generation module 208 may generate a search result 112 based on a set of results obtained by the social media determination module and the social media search module. The search result 112 may include an availability of a particular trademark name among the available social media sites. The merge module 210 may merge data between the social media generation module 208 and a government data 200. The merge module 210 may check the current and/or updated status of the trademarks from the government data 200. In an example embodiment, the merge module 210 may present and display the merged search result in the markup language file through a presentation module 212. The presentation module 212 may generate the markup language page with a thumbnail view page 400 (as illustrated on FIG. 4A and FIG. 4B). For example the markup language file may include XML, Tex, HTML, etc. In one or more embodiments, the user may be directed to the government data when the user selects the thumbnail view page 400. In one or more embodiments, the user may be directed to the social media site when the user selects the thumbnail view page 400.

In one or more embodiments, the search server 100 may automatically perform a set of searches when a user of the search server wishes to follow a particular brand or trademark. In one or more embodiments, the search server may be programmed to perform daily searches of the particular brand or trademark. In one or more embodiments, the search server 100 may apply the suitable algorithm at predetermined intervals to generate a set of search results to an automated query configured by the search server. In one or more embodiments, the social media generation module 208 and the merge module 210 may automatically merge data from the government data 200 and the social media generation module 208. In one or more embodiments, the presentation module 212 may automatically send out an alert to the user or client when a new search result is obtained. In one or more embodiments, the presentation module may not send an alert when no new information or search result is obtained.

In one or more embodiments, the search algorithm may be configured to search for names or usernames on the social media site that may match a search query entered by the user through a client device. For example, a user may create an account with the search server and may select potential names or brands to track. The search server 100 may automatically generate a set of results through the social media generation module 208 and merge the data with government data 200 through the merge module 210. The presentation module 212 may automatically present at predetermined intervals, in one or more embodiments. In one or more embodiments, the presentation module 212 may deliver an alert to the user with the search result at predetermined intervals. In one or more embodiments, the alert to the user may be an email, a text message, a social media alert or any other type of alert. In one or more embodiments, the user may only receive an alert when a content of a new search result is different from the content of the previous search result.

For example, a user A may be an owner of a particular mark “ABC”. There may be an other mark in the process of registration that may be phonetically or visually similar to “ABC”. The other mark may be well on its way to getting registered and may currently be in the “Opposition” phase of trademark prosecution. The “opposition” phase of trademark prosecution may afford an individual to oppose a mark from being registered with the USPTO. The user A who may be the owner of “ABC” may automatically receive an alert through the presentation module that the other mark that is similar to “ABC” is currently in the “Opposition” phase of trademark prosecution. This may, in turn, afford user A a chance to formally oppose the similar mark in front of the USPTO. Otherwise, user A may never have even been alerted of an existence of the similar mark. In one or more embodiments, the search server 100 may communicate with user A based on contact information that may be part of the government data 200.

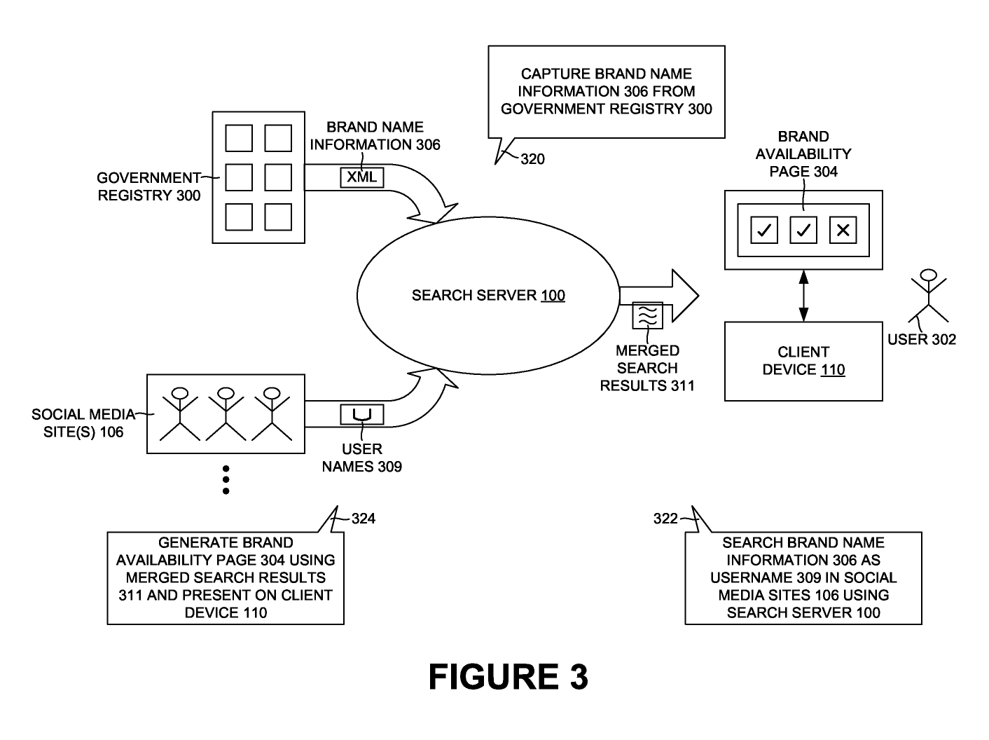

FIG. 3 is a schematic view of a brand name search and generation of a brand availability page, according to one or more embodiments. A government registry 300, such as a trademark database, may contain brand name information 306 in markup language form. In one or more embodiments, the government register 300 may contain government data to be used by the search server 100. The government registry may contain a set of information about brand names, registered trademarks, and marks that are in the process of registration. The government registry 300 may also contain a status of the trademark and an entire history of prosecution of the trademark in markup language form. The markup language may be XML, Tex, HTML, etc., or any other markup language. The brand information name information 306 may be captured from the government registry 300 by the search server 100. The search server 100 then searches for the brand name information 306 as a username 309 on one or more social media sites 106. The search server may then apply the set of social media algorithms and may search a set of social media sites 106 for usernames that may match a search query. The search query may either be manually entered by a user through a client device or may be automatically generated based on a preference of a user, as discussed previously. As discussed above, the search query may be automatically generated at predetermined intervals when a user is interested in tracking a particular brand or name or when a mark is in opposition stage. In one or more embodiments, the search query may be automatic based on other user preferences as customized by the user as well. In one or more embodiments, the search server may capture the brand name or trademark information from the government registry 300 and also search social media sites and merge the set of search results obtained from the government registry 300 and the social media sites to generate a brand availability page 304. The search server 100 may search brand name information 306 as a username 309 in social media sites 106 and then merge the results on the brand availability page 304. The brand availability page 304 may be accessible by the user 302 through the client device 110. The search server 100 may then create merged search results 311 and then generate the brand availability page 304 using the merged search results 311. The brand availability page 304 may then be presented on the client device 110 for the user 302 to view.

FIG. 4A and FIG. 4B illustrate a thumbnail view page with screenshots of brand name information availability on social media sites, according to one or more embodiments. In one or more embodiments, the thumbnail view page 400 may include a brand name search box 406 and a search button 402. The user 302 may input a search query in the brand name search box 406.

In one or more embodiments, the client device may automatically generate the thumbnail view page 400. The thumbnail view page may comprise a thumbnail view 408 comprise a set of screenshots 404 presented in a tiled fashion, as illustrated in FIG. 4B. Availability of a user name 309 and infringement may be visually inspectable by the user 302 in each set of screenshots generated in the thumbnail view. In one or more embodiments, the user 302 may view a larger screen shot 410 upon holding the mouse cursor over the appropriate thumbnail (as illustrated on FIG. 4B).

In one or more embodiments, a user name 309 may be automatically reserved by the search server 100 on the social media site 106 based on a user request. Based on the request of the user 302 the search server 100 may automatically reserve an available user name 309 associated with the brand name on a social media site 106. In one or more embodiments, the search server 100 may also reserve available domain names associated with the brand name information 306 based on the user request.

In one or more embodiments, the user may input a trademark name in the brand name search box 406. The algorithm may format the trademark name by automatically removing stop words, such as spaces or hyphens or special characters. For example, the user may input a search term “Pizza Hut™” in the brand name search box 406. The algorithm may convert that to the username “pizzahut”. The search server may then automatically search multiple social media sites 106 and domains at the same time to determine the availability of the user name 309 in the social media sites 106.

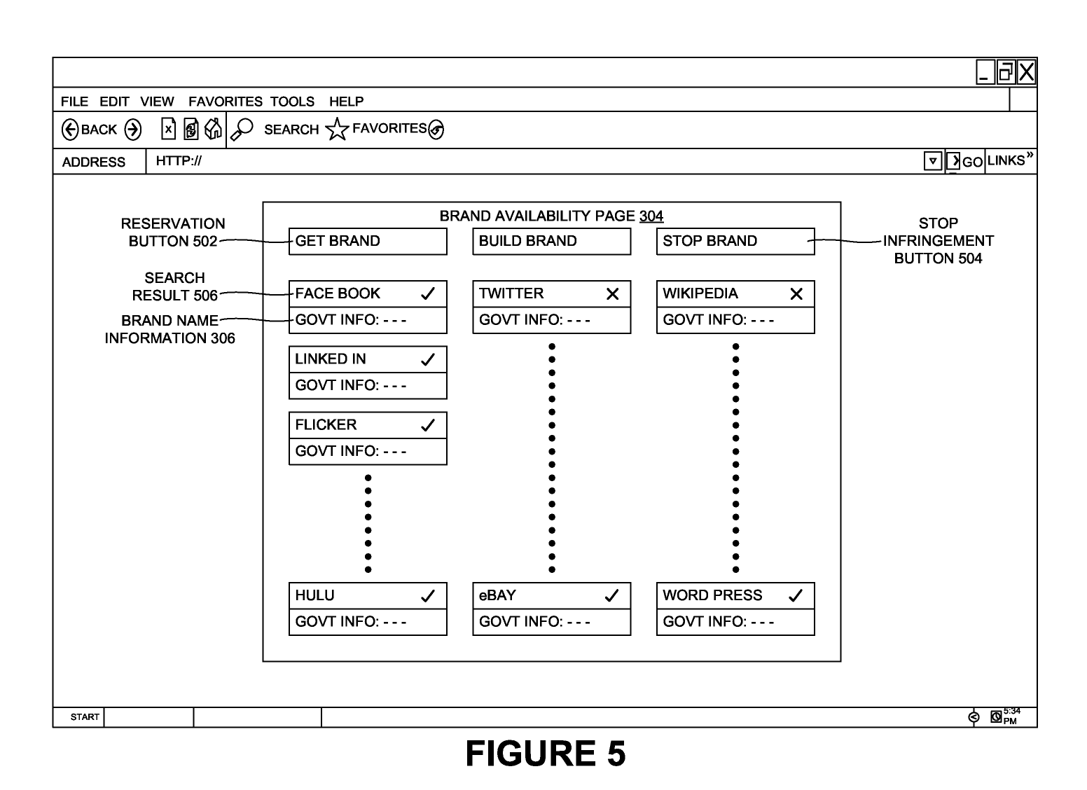

FIG. 5 is a thumbnail view of a brand availability page 304, according to one or more embodiments. In one or more embodiments, the brand availability page 304 may include a reservation button 502 to create a brand name account on the social media site 106 where the brand name account is available. This button may be labeled “Get Brand”, or any other label that indicates to the user 302 that clicking the button reserves their brand name on the social media sites 106 or domain names. The brand availability page 304 may also include a stop infringement button 504 that allows a user to automatically send a take-down notice to the social media site 106 through an attorney. The stop infringement button 504 may also let the user 302 automatically register the brand name information 306 if they have not registered it yet. This button may be labeled “Stop Brand”, or any other label that indicates to the user 302 that clicking the button will stop infringing uses on social media sites 106 or domains.

In one or more embodiments, the brand availability page 304 may be updated periodically by the search server 100. In one or more embodiments, the bran availability page 304 may be updated at predetermined intervals. An updated markup information of the government registry 300 may be applied to the brand name information 306. The updated markup information may perform one or more of an update function, a new data function and/or a delete function.

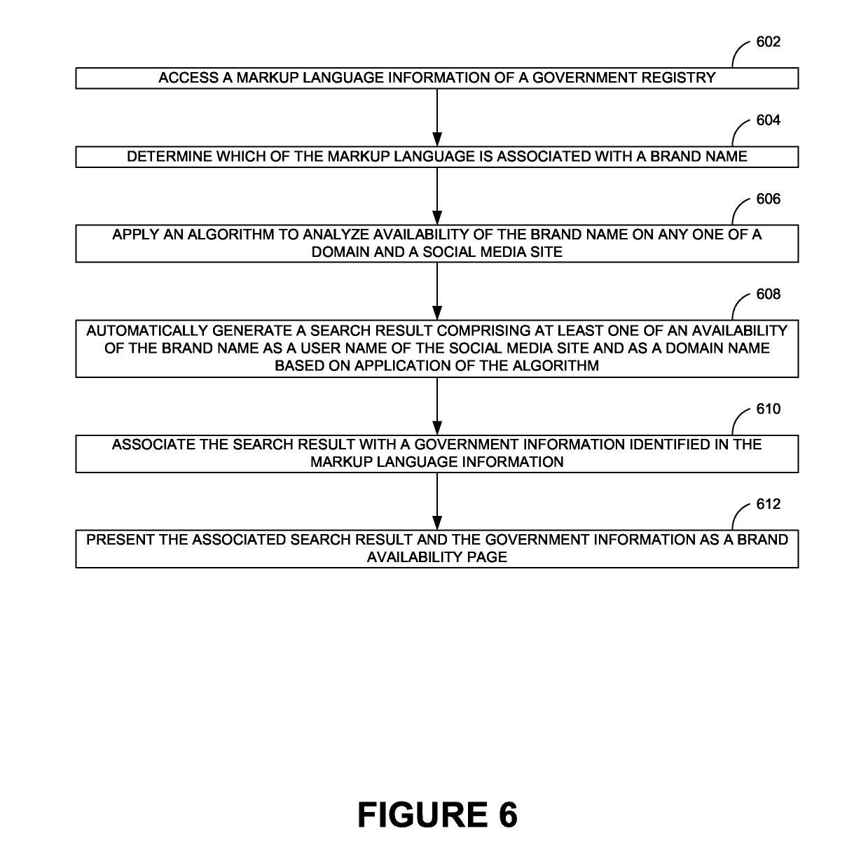

FIG. 6 is a process flow diagram detailing the operation involved in the automatic association of government brand information with domain and social media availability, according to one or more embodiments. In one or more embodiments, in operation 602, the search server may access the markup language information of the government database. In operation 604, the search server may determine which of the markup language information is associated with the brand name. In operation 606, an algorithm may be applied to analyze the availability of the brand name on any one of the domain and social media site. In operation 608, a search result may be generated based on the request of the user comprising one or more of the availability of the brand name as the user name of the social media site and as a domain name based on the application of the algorithm. In operation 610, the search result may be associated with the government information identified in the markup language information. In operation 612, the associated search result and the government information may be presented to the user 302 as a brand availability page 304.

Although the present embodiments have been described with reference to specific example embodiments, it will be evident that various modifications and changes may be made to these embodiments without departing from the broader spirit and scope of the various embodiments.

What is claimed:

1. A method, comprising:
accessing a markup language information of a government registry;
determining which of the markup language information is associated with a brand name;
applying an algorithm to analyze availability of the brand name on any one of a domain and a social media site;
automatically generating a search result comprising at least one of an availability of the brand name as a user name of the social media site and as a domain name based on the application of the algorithm;
associating the search result with a government information identified in the markup language information; and
presenting the associated search result and the government information on a brand availability page.

2. The method of claim 1 further comprising:
automatically generating a thumbnail view of each item of the search result on a thumbnail view page, wherein the thumbnail view comprises a set of screenshots presented in a tiled fashion, and such that availability and infringement is visually inspectable in each of the set of screenshots generated in the thumbnail view.

3. The method of claim 1 wherein the algorithm analyzes an on page content associated with at least one of the domain and the social media site to determine at least one of a presence and an absence of a frequently occurring string of data indicating an available status and a reserve status of the brand name on any one of the domain and the social media site.

4. The method of claim 3 further comprising:
automatically reserving an available user name associated with the brand name on social media sites based on a user request; and
automatically reserving an available domain names associated with the brand name based on the user request.

5. The method of claim 4 further comprising:
automatically generating a social media infringement analysis page having a username screenshot of an unavailable social media user name, wherein the infringement analysis page includes a larger time stamped social media user name screenshot; and
automatically generating a domain infringement analysis page having a domain screenshot of an unavailable domain name, wherein the domain infringement analysis page includes a larger time stamped content on the unavailable domain name.

6. The method of claim 5 further comprising:
periodically updating the brand availability page when an updated markup information of the government registry is applied to the government information, wherein the updated markup information performs at least one of an update function, a new data function, and a delete function.

7. The method of claim 6 further comprising:
removing a stop word from the markup language information and the updated markup information when applying the algorithm to analyze availability of the brand name on any one of the domain and the social media site.

8. A method, comprising:
analyzing an on page content associated with at least one of a domain and a social media site to determine at least one of a presence and an absence of a frequently occurring string of data indicating an available status and a reserve status of a brand name on any one of the domain and the social media site;
automatically generating a search result comprising at least one of an availability of the brand name as a user name of the social media site and as a domain name based on an analysis of the on page content; and
associating the search result with a government information identified in a markup language information of a government database.

9. The method of claim 8 further comprising:
accessing the markup language information of the government database;
determining which of the markup language information is associated with the brand name;
applying an algorithm to analyze availability of the brand name on any one of the domain and the social media site;
presenting the associated search result and the government information on a brand availability page; and
automatically generating a thumbnail view of each item of the search result on a thumbnail view page, wherein the thumbnail view comprises of a set of screenshots presented in a tiled fashion, and such that availability and infringement is visually inspectable in each of the set of screenshots generated in the thumbnail view.

10. The method of claim 9 further comprising:
automatically reserving available user names associated with the brand name on social media sites based on a user request; and
automatically reserving available domain names associated with the brand name based on the user request.

11. The method of claim 10 further comprising:
automatically generating a social media infringement analysis page having a username screenshot of an unavailable social media user name, wherein the infringement analysis page includes a larger time stamped social media user name screenshot; and
automatically generating a domain infringement analysis page having a domain screenshot of an unavailable domain name, wherein the domain infringement analysis page includes a larger time stamped content on the unavailable domain name.

12. The method of claim 11 further comprising:
periodically updating the brand availability page when an updated markup information of the government database is applied to the government information, wherein the updated markup information performs at least one of an update function, a new data function, and a delete function.

13. The method of claim 12 further comprising:
removing a stop word from the markup language information and the updated markup information when applying the algorithm to analyze availability of the brand name on any one of a domain and a social media site.

14. The method of claim 13 in the form of a machine readable medium containing a set of instructions that cause a machine to perform the operations of claim 8.

15. A system, comprising:
a network;
a government server having a government database coupled with the network;
a search server having a module coupled with the network to automatically generate a search result comprising at least one of an availability of a brand name of the government database as a user name of the social media site and as a domain name based on an the analysis of the on page content; and
a client device to present the search result with a government information identified in the government database.

16. The system of claim 15, wherein:
the search server accesses a markup language information of the government database using the network, determines which of the markup language information is associated with the brand name, applies an algorithm to analyze availability of the brand name on any one of the domain and the social media site;
the client device presents the search result and the government information on a brand availability page; and
the client device automatically generates a thumbnail view of each item of the search result on a thumbnail view page, wherein the thumbnail view comprises a set of screenshots presented in a tiled fashion, and such that availability and infringement is visually inspectable in each of the set of screenshots generated in the thumbnail view.

17. The system of claim 15 wherein:
the search server automatically reserves an available user name associated with the brand name on the social media site based on a user request; and
the search server automatically reserves an available domain name associated with the brand name based on the user request.

18. The system of claim 15 wherein:
the search server automatically generates a social media infringement analysis page having a username screenshot of an unavailable social media user name, wherein the infringement analysis page includes a larger time stamped social media user name screenshot; and
the search server automatically generates a domain infringement analysis page having a domain screenshot of an unavailable domain name, wherein the domain infringement analysis page includes a larger time stamped content on the unavailable domain name.

19. The system of claim 15 wherein:
the search server periodically updates the brand availability page when an updated markup information of the government database is applied to the government information, wherein the updated markup information performs at least one of an update function, a new data function, and a delete function.

20. The system of claim 15 wherein:
the search server removes a stop word from the markup language information and the updated markup information when applying the algorithm to analyze availability of the brand name on any one of the domain and the social media site.
